(19) United States
(12) Patent Application Publication
(10) Pub. No.: US 2018/0004224 A1
(43) Pub. Date: Jan. 4, 2018

(54) AUTONOMOUS DRIVING UNIT FOR A SELF-DRIVING MOTOR VEHICLE

(71) Applicant: Ford Global Technologies, LLC, Dearborn, MI (US)

(72) Inventors: Christoph ARNDT, Moerlen (DE); Manfred MUELLER, Aachen (DE); Anke DIECKMANN, Bad Marienberg / Eichenstruth (DE)

(73) Assignee: Ford Global Technologies, LLC, Dearborn, MI (US)

(21) Appl. No.: 15/635,323

(22) Filed: Jun. 28, 2017

(30) Foreign Application Priority Data
Jul. 1, 2016 (DE) 102016212009.3

(51) Int. Cl. G05D 1/02

(52) U.S. Cl. CPC G05D 1/0274; G05D 1/0221

(57) ABSTRACT

An autonomous driving unit for a self-driving motor vehicle is provided. The autonomous driving unit includes a memory that stores route data for a determined route, wherein the route data are based on the drive along the determined route. The autonomous driving unit also includes a control unit, which is connected to the memory, and includes a driving mode for autonomously driving along the determined route with the aid of the route data stored for the determined route.

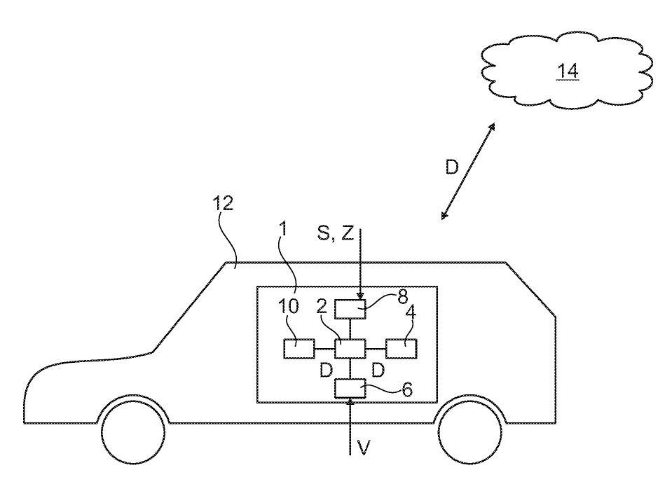

### CROSS-REFERENCE TO RELATED APPLICATIONS

This application claims foreign priority benefits under 35 U.S.C. §119(a)-(d) to DE Application 10 2016 212 009.3 filed Jul. 1, 2016, which is hereby incorporated by reference in its entirety.

### TECHNICAL FIELD

The disclosure relates to a method for operating a self-driving motor vehicle. Furthermore, the disclosure relates to an autonomous driving unit for a self-driving motor vehicle, and a motor vehicle.

### BACKGROUND

An automobile or another motor vehicle, which has an autonomous driving unit and can therefore drive, control, and park without influence of a human driver (highly automated driving) is referred to as a self-driving motor vehicle (sometimes also an autonomous land vehicle). The driver's seat can therefore remain empty; steering wheel, brake pedal, and gas pedal are possibly not provided. Furthermore, utility vehicles, agricultural tractors, and military vehicles without influence of the driver or entirely without a driver also fall under the term “self-driving motor vehicle”.

Autonomous motor vehicles can perceive the surroundings thereof with the aid of various sensors and can determine the position thereof and of the other road users from the obtained items of information, depart for a destination in cooperation with the navigation software, and avoid collisions on the route.

Self-driving motor vehicles are advantageous in particular for older humans, who are otherwise no longer capable of managing, for example, critical traffic situations. This relates in particular to older humans who reside in rural regions and rely on a motor vehicle for their daily errands. This involves often frequented routes, because they depart for the corresponding destinations regularly. On the other hand, in particular in rural regions, the roads have a deficient identification of the roadway edges, for example, which makes the navigation of self-driving motor vehicles more difficult.

It is therefore the object of the disclosure to show ways in which the functional reliability of self-driving motor vehicles can be increased.

### SUMMARY

The method according to the disclosure for operating a self-driving motor vehicle comprises the following steps:
driving along a route using a motor vehicle, wherein the motor vehicle is guided by a motor vehicle driver,
acquiring and storing route data while driving along the route using the motor vehicle, and
retrieving and using the route data during the drive along the route by the self-driving motor vehicle, wherein the self-driving motor vehicle is guided by an autonomous driving unit.

In this way, the self-driving motor vehicle or the autonomous driving unit of the self-driving motor vehicle first learns a route before the self-driving motor vehicle drives along this route in the autonomous operating mode and thus items of information are provided, which enable reliable, autonomous guiding of the motor vehicle, for example, also in rural regions having roads with missing roadway markings.

According to one embodiment, the route data are transmitted from the motor vehicle guided by a motor vehicle driver to the self-driving motor vehicle. Thus, for example, firstly a route is driven using a conventional, non-self-driving motor vehicle, to generate a route data set. In a further step, these route data are transmitted from the non-self-driving motor vehicle to the self-driving motor vehicle, for example, by means of a wireless radio connection. This can be useful, for example, if the self-driving motor vehicle is no longer configured for guiding by a motor vehicle driver at all and, for example, the steering wheel is missing.

According to a further embodiment, the motor vehicle guided by a motor vehicle driver is the self-driving motor vehicle. In this case, the self-driving motor vehicle or the autonomous driving unit can acquire and store the route data. Thus, firstly a route is driven along using the self-driving motor vehicle here, wherein the motor vehicle is steered by a motor vehicle driver here. Accordingly, this motor vehicle is both self-driving and also steerable in a conventional manner by a motor vehicle driver.

According to a further embodiment, route data are acquired and stored for a plurality of routes having an identical starting point and/or destination. Starting points and destinations comprise geographical coordinates or other designations of starting points and destinations, for example, city names and/or road names

According to a further embodiment, at the beginning of a trip, after input of a starting point and/or destination, items of traffic information are taken into consideration during the selection of a route from the plurality of the routes. The items of traffic information may also comprise items of route information. The items of route information can be data relating to construction sites, route closings, blockages, and/or snow clearing services in winter. For example, construction sites can influence or change the sensor data such that they negatively influence automatic driving. Thus, deviations of the sensor data caused by traffic information can be taken into consideration and compensated. Thus, for example, a road closing or also a traffic jam can be taken into consideration.

According to a further embodiment, when driving along a route using the self-driving motor vehicle while employing the stored route data, new route data are acquired and stored. In other words, the route data are updated. Thus, new route data are obtained using the motor vehicle sensors, which replace old or out-of-date route data. Thus, changes along the route may be taken into consideration, for example, structural changes that negatively influence sensor signals.

According to a further embodiment, the route data are stored in a memory of the self-driving motor vehicle and/or a cloud. An access to the route data stored in the memory of the self-driving motor vehicle is also possible without a wireless data connection. The cloud is provided by its one or also multiple computers or a network and does not have to be located in the vicinity of the self-driving motor vehicle. The route data can be provided by the cloud, for example, only to the motor vehicle driver by password protection, or the route data are publicly provided. The number of the trips during a learning phase can be reduced by the access to public route data, because not every motor vehicle driver has to drive along a determined route himself. At the same time, the mobility is thus increased.

A computer program product according to the disclosure comprises software components for carrying out the method according to the disclosure.

An autonomous driving unit according to the disclosure for a motor vehicle is designed for the purpose of reading in route data for a determined route, wherein the route data are based on driving along the determined route. In addition, the autonomous driving unit comprises a control unit, which has a driving mode for autonomously driving along the determined route with the aid of the route data stored for this route. The route data can be read out from a memory, which is associated with the autonomous driving unit, and/or the route data are read out from a cloud, wherein a corresponding interface is associated with the autonomous driving unit for this purpose.

If the possibility is to be provided of acquiring the route data using the motor vehicle having the autonomous driving unit, the autonomous driving unit additionally comprises an acquisition device for acquiring route data during the drive along the determined route by a motor vehicle driver, and the control unit is also connected to the acquisition device. In addition, the control unit then has an acquisition mode for acquiring and storing the route data during the drive along the determined route by the motor vehicle driver. Additionally or alternatively, the possibility exists of transferring route data, which were obtained during the drive along the determined route by another motor vehicle, in a wired or wireless manner or by means of a data carrier to the autonomous driving unit and storing the data in its memory.

The autonomous driving unit according to the disclosure is designed for executing the method according to the disclosure, so that the properties and advantages mentioned with reference to the method according to the disclosure also apply to the autonomous driving unit according to the disclosure.

A self-driving motor vehicle according to the disclosure is equipped with an autonomous driving unit according to the disclosure. The method according to the disclosure may be carried out using the self-driving motor vehicle according to the disclosure, so that the properties and advantages mentioned with reference to the method according to the disclosure also apply to the self-driving motor vehicle according to the disclosure.

The disclosure will now be explained on the basis of a drawing. In the FIGURE:

### BRIEF DESCRIPTION OF THE DRAWINGS

The FIGURE shows an exemplary embodiment of a motor vehicle having an autonomous driving unit according to the disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

A self-driving motor vehicle 12, for example, in the form of a passenger automobile, having an autonomous driving unit 1 according to the disclosure, will be described hereafter with reference to the FIGURE.

The autonomous driving unit 1 according to the disclosure has a control unit 2, which is connected for data transmission to a memory 4. Furthermore, the autonomous driving unit 1 is designed in the present exemplary embodiment to exchange data in a wireless manner with a cloud 14. The autonomous driving unit 1 has a corresponding interface for this purpose. The cloud 14 is provided by one or also multiple computers and/or a network. The cloud 14 is independent of the autonomous driving unit 1. Therefore, it does not have to be located in the vicinity of the autonomous driving unit 1. Furthermore, the autonomous driving unit 1 has an interface 6 in the present exemplary embodiment, to read in items of traffic information V.

Furthermore, the control unit 2 is designed for the purpose of reading in a destination Z, which is input via an input device 8 designed, for example, as a touchscreen, a speech input unit, or another HMI (HMI: Human Machine Interface), and a starting point S, which is possibly also input via the input device 8, for example, in the form of GPS coordinates. The input device 8 designed as an HMI interface can have freely assignable storage spaces identified by displayed symbols, to which determined destinations Z can be assigned, for example, the addresses of children of the motor vehicle driver or regularly used shopping options.

In an autonomous driving mode of the autonomous driving unit 1, it can then read in the route data D stored in the memory 4 or the cloud 14 and autonomously drive along the route between the starting point S and the destination Z with the aid of the read-in route data D.

The route data D stored in the memory 4 can be obtained in an acquisition mode of the autonomous driving unit 1. The route is driven along by a motor vehicle driver in the acquisition mode. The control unit 2 causes an acquisition unit 10 connected thereto to acquire the route data D as the motor vehicle driver drives along the route. The control unit 2 stores the acquired route data D in the memory 4.

The drive along the route by a motor vehicle driver in the acquisition mode can be considered to be a learning phase of the autonomous driving unit 1. During this learning phase, in which at least one route is driven along by way of guiding by a motor vehicle driver after input of the starting point S and the destination Z, the route data D are acquired by the acquisition device 10, which can access vehicle sensors, for example, or can comprise separate sensors. For example, optical sensors and/or radar sensors and/or LIDAR sensors, etc. of the motor vehicle, or of the acquisition device 10, come into consideration as sensors. The acquired route data D are then stored together with an association with the starting point S and the destination Z in the memory 4 or the cloud 14. The route data D can be considered to be a type of specific map of the route between starting point S and the destination Z.

Alternatively, the routes between the starting point S and the destination Z are to be driven along using a second motor vehicle and at the same time the route data D are to be acquired and recorded. After ending the trip, the route data D are then transmitted from the second motor vehicle together with an association with the starting point S and the destination Z into the memory 4 of the first, self-driving motor vehicle, for example, via a wireless radio connection. Additionally or alternatively, the route data D can also be stored in the cloud 14 and either only provided to the motor vehicle driver, for example, with password protection, or the route data D are provided publicly. The number of the trips during a learning phase can be reduced by the access to public route data D, because not every motor vehicle driver has to drive along a determined route himself. The mobility is thus also increased.

Multiple routes can be driven along between an identical starting point S and an identical destination Z and the route data set D or the specific map of the route between starting point S and the destination Z can thus be quasi-expanded with multiple alternative routes.

After the end of the learning phase, a user of the self-driving motor vehicle now inputs by means of an input device, for example, by means of the input device 8, at least the destination Z of the trip, if the self-driving motor vehicle 12 is designed for autonomous location determination and therefore for determination of the starting point S. Otherwise, the input of the starting point S is additionally performed.

Upon the input or ascertainment of the starting point S and the input of the destination Z, the control unit 2 reads out the memory 4 or the cloud 14 and ascertains the route data D associated with the starting point S and the destination Z. In this case, the retrievable route data D of the memory 4 can be related to the motor vehicle driver or can be public. Driver-related data are person-linked, while public data are accessible to anyone, so that in the latter case, a greater selection of route data D exists. If multiple route data D are present, which connect the starting point S to the destination Z, the control unit 2 additionally inputs items of traffic information V via the interface 6 and evaluates them as to whether, for example, a road which connects the starting point S to the destination Z is blocked or a traffic-jam-related delay is to be expected there. If this is the case, the control unit 2 selects a suitable route connecting the starting point S and destination Z in consideration of the items of traffic information V.

During the trip, the control unit 2 accesses the route data D, to steer the motor vehicle 12 autonomously to the destination Z. Furthermore, it is monitored whether items of traffic information V are provided, which make a route change necessary, for example, as a result of a road closing or a traffic jam. In this case, the control unit 2 searches for an alternative route.

In the present exemplary embodiment, the items of traffic information also comprise items of route information. The items of route information are data relating to construction sites, route closings, blockages, and/or snow clearing services in winter. A construction site can influence or change the sensor data such that they negatively influence automatic driving. Thus, traffic-information-related deviations of the sensor data may be taken into consideration and compensated.

It is additionally provided that during the automated drive along the route, the route data D are updated. New route data D are thus obtained using the motor vehicle sensors of the acquisition device 10, which replace old route data D. Changes along the route, which influence the sensor signals, can thus be taken into consideration.

Therefore, by driving along a route between a starting point S and a destination Z, to obtain route data D, and using these route data D when autonomously driving along the route, reliable, autonomous guiding of the motor vehicle 12 by an autonomous driving unit 1 is also enabled in rural regions and in the case of roads with missing roadway markings.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for operating a self-driving motor vehicle comprising:
driving along a route, wherein a motor vehicle is guided by a motor vehicle driver,
acquiring and storing route data while driving along the route, and
retrieving and using the route data during driving along the route by the motor vehicle, wherein the motor vehicle is guided by an autonomous driving unit.

2. The method as claimed in claim 1 further comprising transmitting the route data by the motor vehicle driver to the motor vehicle.

3. The method as claimed in claim 1 further comprising acquiring and storing route data for a plurality of routes having an identical starting point and/or destination.

4. The method as claimed in claim 3 further comprising, at the beginning of a trip, after input of a starting point and/or destination, considering items of traffic information during the selection of a route from the plurality of routes.

5. The method as claimed in claim 1 further comprising, in response to driving along a route using the motor vehicle while employing the stored route data, acquiring and storing new route data.

6. The method as claimed in claim 1, wherein the route data are stored in at least one of a memory of the motor vehicle or a cloud.

7. The method as claimed in claim 1 further comprising providing items of information indicative of missing roadway marking along the route.

8. An autonomous driving unit for a self-driving vehicle, comprising:
a control unit configured to read in route data for a determined route, the route data being based on driving along the determined route wherein the control unit is configured to operate in a driving mode for autonomously driving along the determined route with the aid of the route data stored for the determined route.

9. The autonomous driving unit as claimed in claim 8 further comprising an interface associated with the control unit for storing the route data in a cloud.

10. The autonomous driving unit as claimed in claim 7 further comprising an acquisition unit connected to the control unit and configured to acquire route data along the determined route, wherein the control unit is further configured to operate in an acquisition mode to acquire and store the route data along the determined route.

11. The autonomous driving unit as claimed in claim 7, wherein the control unit is further configured to provide items of information along the determined route having missing roadway markings.

12. A self-driving motor vehicle comprising:
an acquisition unit configured to acquire route data along a determined route, the route data being based on driving along the determined route; and
a control unit configured to read route data for the determined route, wherein the control unit includes a driving mode for autonomously driving along the determined route with the aid of the route data stored for the determined route.

13. The self-driving motor vehicle as claimed in claim 12 further comprising an interface having a memory for storing the route data, the interface being connected to the control unit such that route data is stored in a cloud.

14. The self-driving motor vehicle as claimed in claim 12, wherein the acquisition unit is further configured to acquire and store route data for a plurality of routes having an identical starting point and/or destination.

15. The self-driving motor vehicle as claimed in claim 14, wherein the control unit is further configured to, at the beginning of a trip, after input of a starting point and/or destination, include traffic information during the selection of a route from the plurality of routes.

16. The self-driving motor vehicle as claimed in claim 12, wherein the acquisition unit is further configured to, in response to driving along a route using the motor vehicle while employing the stored route data, acquiring and storing new route data.

17. The self-driving motor vehicle as claimed in claim 12, wherein the route data are stored in a memory of a cloud.

18. The self-driving motor vehicle as claimed in claim 7, wherein the acquisition unit is further configured to provide items of information along the determined route having missing roadway markings.
